(19) United States
(12) Patent Application Publication
(10) Pub. No.: US 2013/0019759 A1
(43) Pub. Date: Jan. 24, 2013

(54) APPARATUS AND METHOD FOR A PRESSURE COOKER LID

(71) Applicants: Mahmut Tumenbatur, Istanbul (TR); Jiang Hu, (US); Cheung Lim Ong, Kowloon Tong (HK); Robert W. Stretton, Auckland (NZ); D. Kim Scott, Feilding (NZ)

(72) Inventors: Mahmut Tumenbatur, Istanbul (TR); Jiang Hu, (US); Cheung Lim Ong, Kowloon Tong (HK); Robert W. Stretton, Auckland (NZ); D. Kim Scott, Feilding (NZ)

(21) Appl. No.: 13/554,639

(22) Filed: Jul. 20, 2012

(30) Foreign Application Priority Data
Jul. 21, 2011 (CN) 201120259567.2

(51) Int. Cl. A47J 27/08; A47J 36/10; B23P 11/00; A47J 27/09

(52) U.S. Cl. 99/337; 126/374.1; 220/324; 29/428

(57) ABSTRACT

A pressure cooker lid includes a lid body, one or more lid clamps, a pressure valve, and a single control mechanism operable to sequentially control radial movement of the one or more lid clamps and control actuation of the pressure valve. Each of the one or more lid clamps includes a connection element and a clamp element. The pressure valve includes a valve stem. The control mechanism includes a rotary disc coupled to the connection elements and a knob mechanism operable to drive rotation of the rotary disc. Rotation of the rotary disc sequentially drives radial movement of the connection elements and axial movement of the valve stem to operate pressure valve.

### CROSS-REFERENCE TO RELATED APPLICATIONS

This application claims priority to Chinese Patent Application No. 201120259567.2 filed on Jul. 21, 2011, which is incorporated by reference in its entirety herein.

### BACKGROUND

Many pressure cooker devices typically include a fastening mechanism operable to engage a pressure cooker lid to a pressure cooker pot. Pressure cooker lids may also include a separate mechanism to regulate the pressure in the pressure cooker during operation. Pressure cooker lids may further include a separate mechanism to release pressure during use of a pressure cooker device. It may however be cumbersome for a user to operate separate fastening, pressure control, and pressure release mechanisms during use of a pressure cooker.

### SUMMARY

Briefly, aspects of the present disclosure are directed to a pressure cooker lid, including a lid body, one or more lid clamps, a pressure valve, and a single control mechanism operable to sequentially control radial movement of the one or more lid clamps and actuation of the pressure valve. Each of the one or more lid clamps may include a connection element and a clamp element. The pressure valve may include a valve stem. The control mechanism may include a rotary disc coupled to one or more of the connection elements and a knob mechanism operable to drive rotation of the rotary disc. Rotation of the rotary disc may sequentially drive radial movement of the connection elements and drive movement of the valve stem along an axial direction of the pressure valve.

This SUMMARY is provided to briefly identify some aspects of the present disclosure that are further described below in the DESCRIPTION. This SUMMARY is not intended to identify key or essential features of the present disclosure nor is it intended to limit the scope of any claims.

The term “aspects” is to be read as “at least one aspect”. The aspects described above and other aspects of the present disclosure described herein are illustrated by way of example(s) and not limited by any of the accompanying figures.

### BRIEF DESCRIPTION OF THE DRAWING

A more complete understanding of the present disclosure may be realized by reference to the accompanying figures in which:

FIG. 1 depicts a perspective view of a pressure cooker lid according to aspects of the present disclosure;

FIG. 2 depicts a top view of a pressure cooker lid according to aspects of the present disclosure;

FIG. 3 depicts a partial section view of a pressure cooker lid according to aspects of the present disclosure;

FIG. 4 depicts the top view of FIG. 2 emphasizing certain additional aspects of the present disclosure;

FIG. 5 depicts the partial section view of a FIG. 3 emphasizing certain additional aspects of the present disclosure;

FIG. 6 depicts the top view of FIG. 2 emphasizing certain additional aspects of the present disclosure;

FIG. 7 depicts the partial section view of FIG. 3 emphasizing certain additional aspects of the present disclosure;

FIG. 8 depicts the top view of FIG. 2 emphasizing certain additional aspects of the present disclosure;

FIG. 9 depicts the partial section view of FIG. 3 emphasizing certain additional aspects of the present disclosure;

FIG. 10 depicts another perspective view of a pressure cooker lid according to aspects of the present disclosure; and

FIG. 11, depicts a table of pressure cooker lid operational states according to aspects of the present disclosure.

The illustrative aspects are described more fully by the Figures and detailed description. The present disclosure may, however, be embodied in various forms and is not limited to specific aspects described in the Figures and detailed description.

### DESCRIPTION

Reference will now be made in detail to exemplary aspects of the present disclosure, including the best modes contemplated by the inventors for carrying out aspects of the disclosure. Examples of these exemplary aspects are illustrated in the accompanying drawings. While the disclosure is described in conjunction with these aspects, it will be understood that it is not intended to limit the invention to the described aspects. Rather, the disclosure is also intended to cover alternatives, modifications, and equivalents as may be included within the spirit and scope of the disclosure as defined by the appended claims. In the following description, specific details are set forth in order to provide a thorough understanding of the present disclosure. Aspects of the present disclosure may be practiced without some or all of these specific details. In other instances, well-known aspects have not been described in detail in order not to unnecessarily obscure the present disclosure.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this disclosure belongs.

Unless otherwise explicitly specified herein, the drawings are not drawn to scale.

The pressure cooker lid (for example, cover) of the present disclosure provides a device that is simple in structure and convenient to use. The pressure cooker lid includes a control mechanism (for example, a control interface) operable to control two or more pressure cooker functions including, for example, pressure cooker lid attachment, cooking pressure adjustment, pressure release, and/or other functions. A pressure cooker lid control mechanism may control multiple functions including movement of lid clamps and degree of closure of a pressure valve to control the pressure value in the pressure cooker and to release pressure from the pressure cooker.

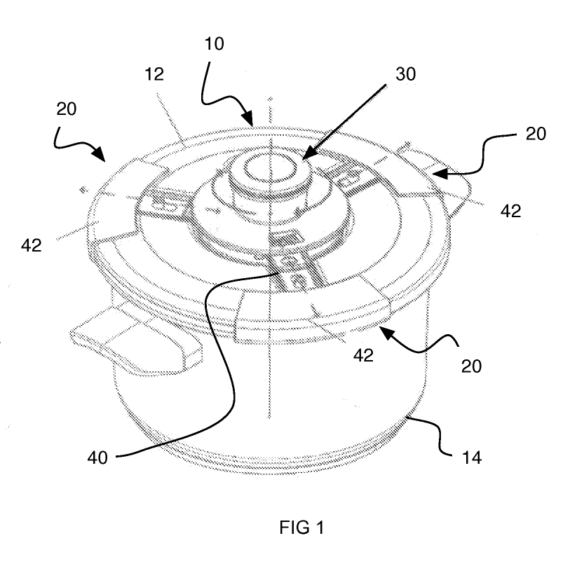

In FIG. 1, there is shown a perspective view of a pressure cooker lid according to aspects of the present disclosure. A pressure cooker lid 10 (for example, a pressure cooker cover) may include a lid body 12, one or more lid clamps 20, a pressure valve (as discussed below), a single control mechanism 30, and/or other components. Each of the one or more lid clamps 20 may include, for example, a connection element 40 (for example, a connection arm) and a clamp element 42 (for example, a claw element). An outer end of a connection element 40 may be connected to a clamp element 42. The pressure cooker lid 10 as illustrated is placed onto a pressure cooker pot 14. The one or more lid clamps 42 are operable to sealably couple the pressure cooker lid 10 to a pressure cooker pot 14.

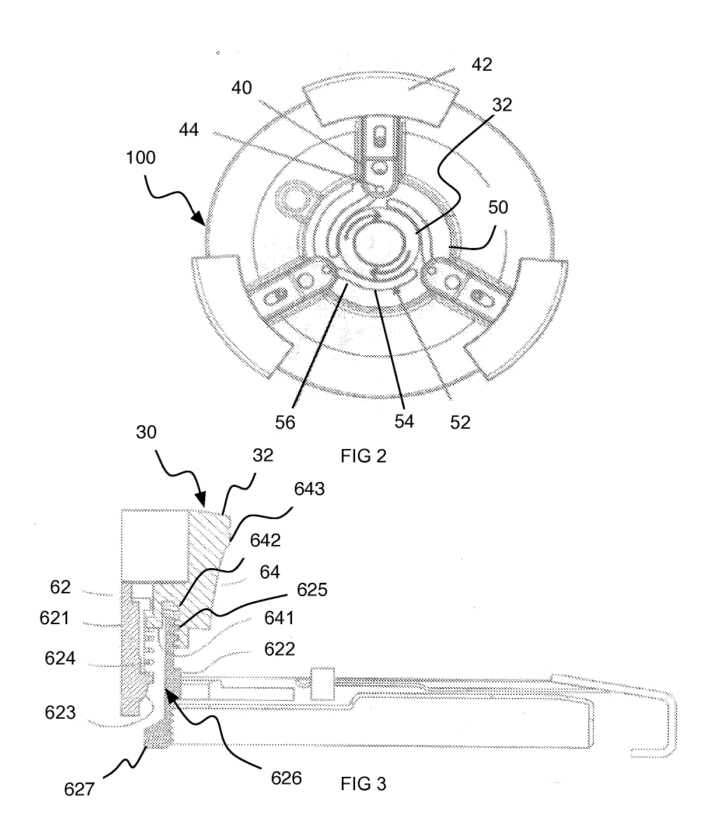

In FIG. 2, there is shown a top view of a pressure cooker lid according to aspects of the present disclosure. FIG. 2 depicts a pressure cooker lid 10 in an open lid position (for example, an open cover position) and a control mechanism 30 in a first position. In an open lid position in which the pressure cooker lid 10 may be positioned to cover an opening of the pressure cooker pot 14, one or more lid clamps 20 are not sealably coupled to (for example, are uncoupled from) the pressure cooker pot 14. The pressure cooker lid 10 can be removed from covering the pressure cooker pot 14 when in an open lid position.

The control mechanism 30 may include, for example, a rotary disc 50 coupled to one or more connection elements 40, a knob mechanism 32 operable to drive rotation of the rotary disc 50, and possibly other elements. Rotation of the rotary disc 50 may, for example, sequentially, concurrently, and/or simultaneously drive radial movement of the connection elements 40 and drive movement of a valve stem (for example, associated with the pressure valve) along an axial direction of a pressure valve. Rotation of the rotary disc 50 may, for example, sequentially drive radial movement of the connection elements 40 then drive movement of the valve stem. Similarly, rotation of the rotary disc 50 may, for example, concurrently and/or simultaneously drive radial movement of the connection elements 40 and drive movement of the valve stem (for example, at same time). The rotary disc 50 may include one or more sliding slots 52. Each of the sliding slots may include, for example, a first slot segment 54 defined by a first arc concentric with the lid body 12 and a second slot segment 56 defined by a second arc. The second slot segment 56 may be defined by the second arc such that a radial distance between a first end (for example, an initial end) of the second slot segment 56 and a center of the lid body 12 is larger than a radial distance between a second end (for example, a terminating end) of the second slot segment 56 and the center of the lid body 12. The second end of the second slot segment 56 may meet the first end of the first slot segment 54.

According to some aspects, each of the connection elements 40 may include a protruding element 44. The protruding element 44 of each connection element 40 may be coupled to one or more sliding slots 52. One or more protruding elements 44 may, for example, slide within one or more sliding slots 52. The protruding elements 44 and the sliding slots 52 may translate relative to one another, resulting in a translation of the lid clamps 20 along a radial direction relative to the lid body 12. The protruding elements 44 may, for example, slide in the sliding slots 52 as a result of rotation of the rotary disc 50. The rotary disc 50 is coupled to the knob mechanism 32 such that the rotary disc 50 may rotate in conjunction with rotation of knob mechanism 32. The knob mechanism 32 may, thus, drive rotation of the rotary disc 50 and translation of lid clamps 20 along a radial direction.

In some aspects, when a pressure cooker lid 12 is in a closed lid position, a protruding element 44 of each connection element 40 may be coupled to a first sliding slot segment 54 of the one or more sliding slots 52. In an open lid position, a protruding element 44 of each connection element 40 may be coupled to a second sliding slot segment 56 of one of the one or more sliding slots 52.

In FIG. 3, there is shown a sectional view of a pressure cooker lid according to aspects of the present disclosure. FIG. 3 may, for example, depict the control mechanism 30 in a first position. As shown in FIG. 3, the pressure cooker lid 10 may include a pressure valve 62 (for example, a pressure limiting valve, pressure control valve, or any other type of pressure valve). The pressure valve 62 may be positioned substantially in the center of the pressure cooker lid 10. The pressure valve 62 may include a valve stem 621. In some aspects, the pressure valve 62 may include a valve body 622, a valve stem reset spring 624 (for example, a compression spring), and/or other components. A valve body 622 may, for example, extend through the lid body 12, and the valve body 622 may include a valve chamber 626 to accommodate the valve stem 621 and an outer threaded surface 625. In some aspects, a sealing element 623 may be affixed to the valve stem 621. The sealing element 623 may, for example, be operable to couple with a valve seat 627 (for example, valve opening) at a bottom of the valve chamber 626 to regulate an operating pressure of the pressure valve 62. The sealing element 623 may comprise metal, stainless steel, or any other suitable material.

According to some aspects, a knob mechanism 32 may include a knob cover 64 including a substantially cylindrical outer surface 643 (for example, a cylindrical outer surface), a pushrod 641, a threaded inner surface 642, and/or other elements. In some aspects, a user may actuate and/or operate the knob mechanism 32 by applying a rotational input (for example, twist input) to knob cover 62 (for example, a substantially cylindrical outer surface) in a direction (for example, clockwise, counter-clockwise, or another direction).

In some aspects, the pressure valve 62 and/or components of the pressure valve 62 may be operably coupled to knob mechanism 64 and/or components of the knob mechanism 32 (for example, knob cover 64). A first end of the valve stem spring 624 may be in substantial contact with a pushrod 641, and a second end of the spring 624 may be in substantial contact with the valve stem 621. A knob cover inner threaded surface 642 may be coupled to a threaded outer surface 625 of the pressure valve.

In some aspects, a rotational input to the knob mechanism 32 in a predefined direction (for example, clockwise, counterclockwise, or another direction) may drive movement of the valve stem 621 along an axial direction toward a closed position of the pressure valve 62. The rotational input to the knob mechanism 32 may drive movement of the knob cover 64 along an axial direction by translating the knob cover inner threaded surface 642 relative to the threaded outer surface 625 of the pressure valve. A pushrod 641 portion of the knob cover 64 may be in substantial contact with the valve stem spring 624, and rotational movement of the knob cover 64 generating movement of the cover 64 in an axial direction may drive compression of the valve stem spring 624. The valve stem spring 624 may be in substantial contact with the pressure valve sealing element 623, and compression of the valve stem spring 624 may drive axial translation of the valve stem 621 to achieve a increase a pressure of the of the pressure valve 62.

In some aspects, when the knob cover 64 is rotated downward, the pressure valve spring 624 and the valve stem 621 may simultaneously translate downward. When the knob cover 64 is moved downward to different positions, a tightness or level of contact between sealing element 623 and the valve seat 627 may vary. When, for example, the sealing element 623 and valve seat 627 are in substantial contact, a significant contact pressure between the sealing element 623 and valve seat 627 is generated. A sealing pressure of the pressure valve 62 may be generated by, for example, contact between the sealing element 623 and valve seat 627. A level of sealing pressure of the pressure valve 62 may be related to a level and/or amount of load and/or pressure between the sealing element 623 and valve seat 627. The level and/or amount of load and/or pressure between the sealing element 623 and valve seat 627 may be related to a level or amount of compression of the pressure valve spring 624. The compression of the pressure valve spring 624 may, for example, apply a load to the sealing element 623. The applied load to the sealing element 623 may increase a force between the sealing element 623 and the valve seat 627. Each valve position may, for example, correspond to a different degree of compression of the pressure valve spring 624 and/or a different operating pressure of the pressure cooker pot 14.

In some aspects, the sealing element 623, valve seat 627, and pressure valve spring 624 may be positioned to define an open valve position (for example, no contact between sealing element 623 and valve seat 627), a partially closed valve position (for example, substantial contact between sealing element 623 and valve seat 627), a fully closed valve position (for example, increased compression of the pressure valve spring 624 and contact between sealing element 623 and valve seat 627), or other possible valve positions. As shown in FIG. 3, the pressure valve 62 may be in, for example, an open position when the sealing element 623 and valve seat 627 are in a non-contacting position.

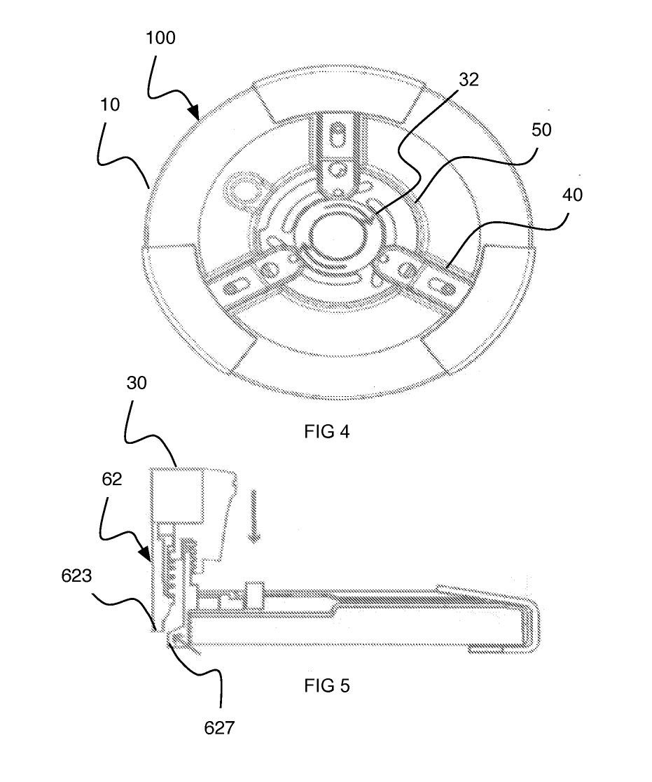

In FIG. 4, there is shown a top view of a pressure cooker lid according to aspects of the present disclosure. FIG. 4 depicts a pressure cooker lid 10 in a closed lid position (for example, a first closed lid position), as may be defined when the control mechanism 30 is in a second position. The knob mechanism 32, upon rotation in a predefined direction (for example, clockwise) may be sequentially operable to first rotate the rotary disc 50 in the predefined direction driving radial movement of the connection elements 40 in a direction towards a center of the lid body 12, and then drive movement of the valve stem along the axial direction toward a closed position of the pressure valve.

In some aspects, the knob mechanism 32 upon rotation in a predefined direction (for example, clockwise) may be sequentially, concurrently, and/or simultaneously operable to translate the one or more lid clamps 20 from an open lid position (as depicted in FIG. 2) to a closed lid position (as depicted in FIG. 4) and to translate a valve stem from an open valve position (as depicted in FIG. 3) to a second valve position (as depicted below in FIG. 5).

In some aspects, as control mechanism 30 is rotated in a predetermined direction from a first position (as depicted in FIG. 2) to a second position (as depicted in FIG. 4) the user turns the knob cover 64, as shown in FIG. 4 and FIG. 5, the protruding column 44 will move to a second end (for example, a terminating end) of the second slot segment 56, and one or more lid clamps 20 may be at a closest distance to the center of the lid body 12. As shown in FIG. 4 when one or more lid clamps 20 are at a closest distance to the center of the lid body 12, the pressure cooker lid 10 may be in a closed lid position.

According to some aspects, a knob mechanism 32, upon rotation in a predefined direction, may be sequentially, concurrently, and/or simultaneously operable to first drive movement of the valve stem 621 along the axial direction toward an open position of the pressure valve 62 and then rotate the rotary disc 50 in the predefined direction driving radial movement of the connection elements 40 in a direction away from a center of the lid body 12. As the valve stem 621 is moved to an open position of the pressure valve 62, for example, as shown in FIG. 3 pressure in the pressure cooker may be reduced and/or released. As the connection elements 40 are driven in a direction away from a center of the lid body 12, for example, as shown in FIG. 2 a seal between the pressure cooker lid 10 and pressure cooker pot 14 may be released.

In FIG. 5, there is shown a sectional view of a pressure cooker lid according to aspects of the present disclosure. FIG. 5 may, for example, depict the control mechanism 30 in a second position. When a control mechanism 30 is in a second position, the pressure valve 62 may be in, for example, an open position. In this position, a sealing element 623 may be positioned at a predefined distance from a valve seat 627.

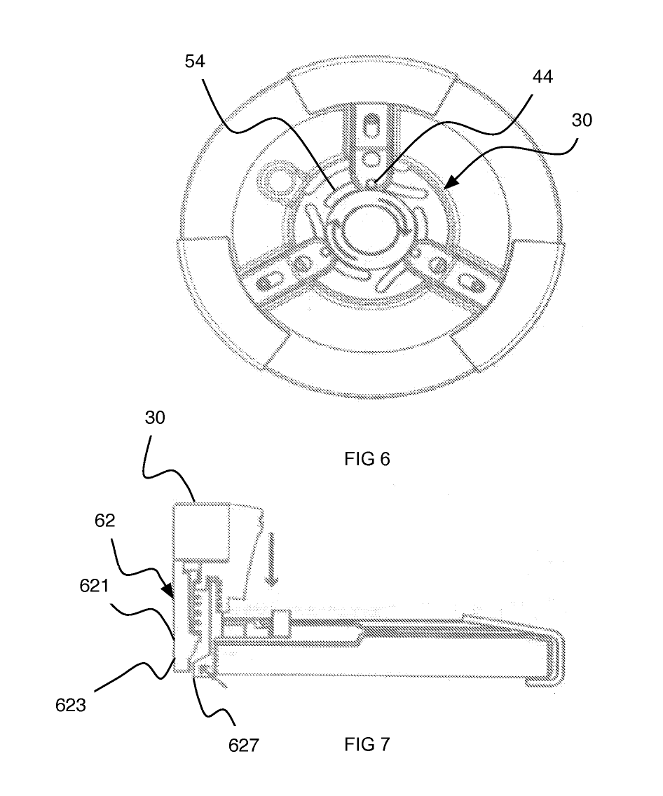

In FIG. 6, there is shown a top view of a pressure cooker lid according to aspects of the present disclosure. FIG. 6 may depict a pressure cooker lid 10 in a closed lid position and may depict the control mechanism 30 in a third position. In some aspects, a control mechanism 30 may be rotated in a predetermined direction (for example, clockwise) from a second position (as depicted in FIG. 4) to a third position (as depicted in FIG. 6). As control mechanism 30 is rotated from a second position to a third position one or more protruding elements 44 may be coupled to and/or translate in first slot segment 54, and one or more clamp elements 20 may remain in a closed lid position.

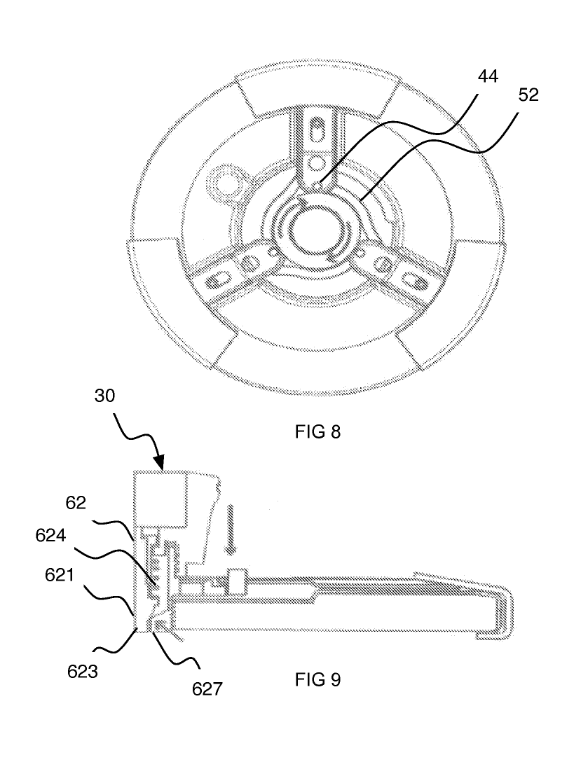

In FIG. 7, there is shown a sectional view of a pressure cooker lid according to aspects of the present disclosure. FIG. 7 may, for example, depict a control mechanism 30 in a third position. When a control mechanism 30 is in a third position, a pressure valve 62 may be in, for example, a partially closed position (for example, substantially closed position). When control mechanism 30 is in a third position, the pressure valve 62 may be in low pressure state. In some aspects, a control mechanism 30 may be rotated in a predetermined direction (for example, clockwise) from a second position (as depicted in FIG. 5) to a third position (as depicted in FIG. 7). Rotating control mechanism 30 from a second position to a third position drives a valve stem 621 along an axial direction from an open position (for example, a substantially open position) to a partially closed position. In a closed position and/or substantially closed position, a valve stem 621 and/or valve stem sealing element 623 may be in substantial contact with a valve seat 627. Note, FIG. 7 shows a gap between the valve stem sealing element 623 and the valve seat 627 in order to delineate the components for descriptive purposes. In operation, the valve stem sealing element 623 may be in substantial contact with a valve seat 627 and no gap or minimal may be present.

In FIG. 8, there is shown a top view of a pressure cooker lid according to aspects of the present disclosure. FIG. 8 may depict a pressure cooker lid 10 in a closed lid position and a control mechanism 30 in a fourth position. As shown in FIG's 4, 6 and 8, when the protruding element 44 is coupled to a first slot segment 52, a distance between the one or more lid clamps 20 and the center of the lid body 12 is minimized and remains substantially unchanged. Thus, when protruding element 44 is coupled to first slot segment 54, pressure cooker lid 10 may be in a closed lid position.

In FIG. 9, there is shown a sectional view of a pressure cooker lid according to aspects of the present disclosure. FIG. 9 may, for example, depict the control mechanism 30 in a fourth position. A knob mechanism 30 may be rotated in a predetermined direction from the third position (as depicted in FIG. 7) to the fourth position (as depicted in FIG. 9). When the control mechanism 30 is in a fourth position, the pressure valve 62 may be in a high pressure state (for example, highest pressure valve state). Rotating control mechanism 30 from the third position to the fourth position may drive a valve stem 621 and/or valve stem sealing element 623 along an axial direction toward valve seat 627. Valve stem sealing element 623 may first contact valve seat 627 to generate a sealing pressure. The sealing pressure may then be increased as the pressure valve spring 624 is compressed. Increasing the compression of the pressure valve spring 624 may increase a force and/or contact pressure between the valve stem sealing element 623 and valve seat 627 thereby increasing an effective operating pressure of the pressure valve 62.

In some aspects, although not shown, the control mechanism 30 may be rotated in a counter-clockwise direction from a first position (as depicted in FIG's 2 and 3) to a second position (as depicted in FIG's 4 and 5), to a third position (as depicted in FIG's 6 and 7) and a fourth position (as depicted in FIG's 8 and 9).

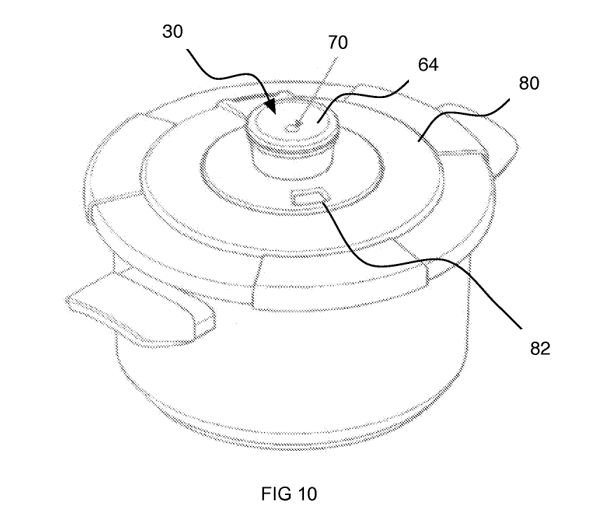

In FIG. 10, there is shown a perspective view of a pressure cooker lid according to aspects of the present disclosure. A control mechanism 30 may include a pressure indicator 70. In some aspects, a pressure indicator 70 may be a marking on a first end of the valve stem (for example, as depicted in for example FIG. 3). A first end of the pressure valve stem may be, for example, a warning color, such as red. When pressure valve 62 is in, for example, a full closed position, the first end of the valve stem may be flush with or substantially flush (for example, located just below) an upper surface of the knob cover 64, and the indicator 70 may be visible above the knob cover 64. When the valve stem is flush or substantially flush with the surface of the knob cover, the indicator 70 may be visible to a user indicating that the pressure cooker may be in a high-pressure state. The indicator 70 may, in some aspects, be flush or substantially flush with a surface of a knob cover 64 when a pressure associated with the pressure valve is above a predefined threshold.

In some aspects, knob cover may include cover element 80. The cover element 80 may cover the connection elements 40, rotary disc 50 and/or other components of the control mechanism 30. Cover element 80 may be fabricated from metal, plastic, or any other suitable materials.

In some aspects, the cover element 80 may include a window element 82. The window element 82 may be glass, clear plastic, or another transparent or translucent material. The window element 82 may, for example, allow a user to determine a position of the control mechanism 30. A user may, for example, determine a rotation position of the control mechanism 30 or components of the control mechanism 30 (for example, the rotary disc 50.

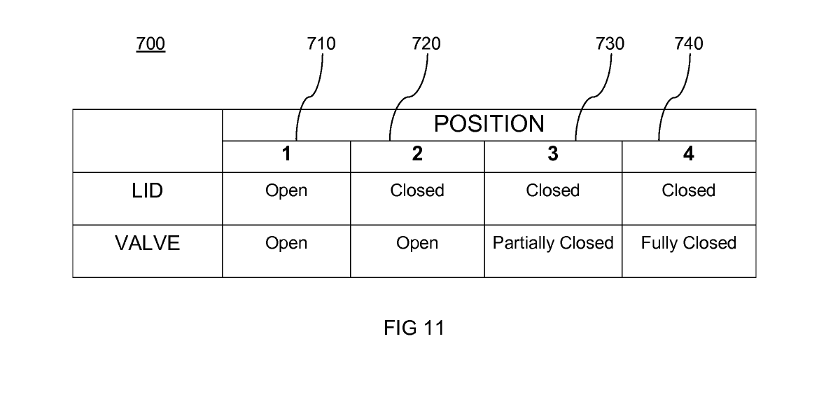

FIG. 11 depicts a table 700 of pressure cooker lid operational states according to aspects of the present disclosure. In a first pressure cooker lid state 710, the pressure cooker lid 10 may be in an open position, the pressure valve 62 may be in an open position, and knob mechanism 32 and/or knob cover 64 may be in an initial rotational position as shown in FIG's 2 and 3. A first pressure cooker lid state 710 may be depicted in, for example, FIG's 2 and 3. In a second pressure cooker lid state 720, the pressure cooker lid 10 may be in an closed position, the pressure valve 62 may be in an open position, and knob mechanism 32 and/or knob cover 64 may be in a second rotational position as shown in FIG's 4 and 5. A second pressure cooker lid state 720 may be depicted in, for example, FIG's 4 and 5. In a third pressure cooker lid state 730, the pressure cooker lid 10 may be in an closed position, the pressure valve 62 may be in a partially closed position, and knob mechanism 32 and/or knob cover 64 may be in a third rotational position as shown in FIG's 6 and 7. The third pressure cooker lid state 730 may be depicted in, for example, FIG's 6 and 7. In a fourth pressure cooker lid state 740, the pressure cooker lid 10 may be in a closed position, the pressure valve 62 may be in a fully closed position, and knob mechanism 32 and/or knob cover 64 may be in a fourth rotational position as shown in FIG's 8 and 9.

At this point, while we have discussed and described the disclosure using some specific examples, those skilled in the art will recognize that our teachings are not so limited. Accordingly, the disclosure should be only limited by the scope of the claims attached hereto.

1. A pressure cooker lid, comprising:
a lid body;
one or more lid clamps;
a pressure valve; and
a single control mechanism operable to sequentially control radial movement of the one or more lid clamps and actuation of the pressure valve.

2. The pressure cooker lid of claim 1,
wherein each of the one or more lid clamps includes a connection element and a clamp element,
wherein the pressure valve includes a valve stem, and
wherein the control mechanism comprises:
a rotary disc coupled to one or more of the connection elements; and
a knob mechanism operable to drive rotation of the rotary disc,
wherein rotation of the rotary disc sequentially drives radial movement of the connection elements and drives axial movement of the valve stem to activate the pressure valve.

3. The pressure cooker lid of claim 2, wherein the knob mechanism, upon rotation in a predefined direction, is sequentially operable to:
first rotate the rotary disc in the predefined direction driving radial movement of the connection elements in a direction towards a center of the lid body; and
then driving the axial movement of the valve stem to close the pressure valve.

4. The pressure cooker lid of claim 2, wherein the knob mechanism, upon rotation in a predefined direction, is sequentially operable to:
first driving the axial movement of the valve stem to open the pressure valve; and
then rotating the rotary disc in the predefined direction driving radial movement of the connection elements in a direction away from a center of the lid body.

5. The pressure cooker lid of claim 2, wherein the knob mechanism upon rotation in a predefined direction is sequentially operable to:
translate the one or more lid clamps from an open lid position to a closed lid position; and
translate the valve stem to change a state of the pressure value from an open valve position to a first closed valve position.

6. The pressure cooker lid of claim 5, wherein the knob mechanism upon further rotation in the predefined direction is operable to:
increase an effective operating pressure of the pressure valve.

7. The pressure cooker lid of claim 2, wherein:
each connection element includes a protruding element;
the rotary disc includes one or more sliding slots, each of the sliding slots including:
a first slot segment defined by a first arc concentric with the lid body; and
a second slot segment defined by a second arc;
wherein the protruding element of each connection element is coupled to one of the sliding slots.

8. The pressure cooker lid of claim 7, wherein:
the second slot segment is defined by the second arc such that a radial distance between a first end of the second slot segment and a center of the lid body is larger than the radial distance between a second end of the second slot segment and the center of the lid body; and
the second end of the second slot segment meets a first end of the first slot segment.

9. The pressure cooker lid of claim 2, wherein the pressure valve further comprises:
a valve body extending through the lid body, the valve body including a valve chamber to accommodate the valve stem and an outer threaded surface; and
a sealing element affixed to the valve stem operable to couple with a valve seat at a bottom of the valve chamber to regulate an operating pressure of the pressure valve.

10. The pressure cooker lid of claim 9, wherein:
the knob mechanism further comprises a knob cover including a substantially cylindrical outer surface and a pushrod;
the pressure valve further comprises a valve stem spring; and
wherein a first end of the valve stem spring is in substantial contact with the pushrod and a second end of the spring is in substantial contact with the valve stem.

11. The pressure cooker lid of claim 10, wherein:
the knob cover includes threaded inner surface coupled to the threaded outer surface of the pressure valve.

12. The pressure cooker lid of claim 2, wherein the control mechanism further comprises a pressure indicator.

13. The pressure cooker lid of claim 12, wherein the pressure indicator comprises a marking associated with a first end of the valve stem, wherein the first end of the valve stem protrudes from a surface of a knob cover when a pressure at the pressure valve is above a predefined threshold.

14. The pressure cooker lid of claim 2, wherein the one or more lid clamps are operable to sealably couple the pressure cooker lid to a pressure cooker pot.

15. The pressure cooker lid of claim 2, wherein the pressure valve is positioned substantially in the center of the pressure cooker lid.

16. A method of operating a pressure cooker comprising the steps of:
providing a pressure cooker lid including:
a lid body;
one or more lid clamps, each lid clamp including a connection element and a clamp element;
a pressure valve including a valve stem; and
a control mechanism operable to control radial movement of the one or more clamps and actuation of the pressure valve;
placing the pressure cooker lid onto a pressure cooker pot;
rotating the control mechanism in a predetermined direction from a first position to a second position thereby causing the one or more lid clamps to move from an open lid position to a closed lid position; and
rotating the control mechanism in the predetermined direction from the second position to a third position, thereby causing an axial movement of the valve stem such that the pressure value is activated to move from an open position to a closed position.

17. The method of claim 16, wherein the control mechanism is operable to:
drive rotation of a rotary disc that controls the radial movement of the connection elements and the axial movement of the valve stem.

18. The method of claim 16, further comprising the step of:
rotating the knob mechanism in the predetermined direction from the third position to a fourth position, and thereby increase an effective operating pressure of the pressure valve.

19. The method of claim 16, wherein:
the pressure valve further comprises:
a valve body extending through the lid body, the valve body including a valve chamber to accommodate the valve stem, and
a sealing element affixed to the valve stem operable to couple with a valve seat at a bottom of the valve chamber to regulate an operating pressure of the pressure valve; and
a valve stem spring in substantial contact with the pressure valve sealing element;
wherein, when the control mechanism is in the second position the sealing element is positioned at a predefined distance from the valve seat; and
wherein, when the control mechanism is positioned at the third position, the sealing element is in contact with the valve seat and the valve stem spring is in a compressed state.

20. The method of claim 16, wherein:
each connection element includes a protruding element;
the rotary disc includes one or more sliding slots, each of the sliding slots including a first slot segment and a second slot segment;
in the open lid position, the protruding element of each connection element is coupled to the second sliding slot segment of one of the one or more sliding slots; and
in the closed lid position the protruding element of each connection element is coupled to the first sliding slot segment of the one or more sliding slots.
